(19) United States
(12) Patent Application Publication
(10) Pub. No.: US 2018/0364653 A1
(43) Pub. Date: Dec. 20, 2018

(54) METHOD AND SOFT SENSOR FOR DETERMINING A POWER OF AN ENERGY PRODUCER

(71) Applicant: SIEMENS AKTIENGESELLSCHAFT, MÜNCHEN (DE)

(72) Inventors: HANS-GERD BRUMMEL, BERLIN (DE); KAI HEESCHE, MÜNCHEN (DE); ALEXANDER HENTSCHEL, VANCOUVER (CA); VOLKMAR STERZING, NEUBIBERG (DE)

(21) Appl. No.: 16/063,330

(22) PCT Filed: Dec. 7, 2016
(86) PCT No.: PCT/EP2016/080072

§ 371 Date: Jun. 18, 2018

(30) Foreign Application Priority Data
Dec. 23, 2015 (DE) 10 2015 226 656.7

(51) Int. Cl. G05B 13/02; G06N 3/08; G05B 17/02

(52) U.S. Cl. CPC G05B 13/027; G05B 17/02; G06N 3/08

(57) ABSTRACT

In order to determine a power output by a first energy producer, wherein the first energy producer is coupled to a second energy producer, a first soft sensor which is trained to determine an individual mode power value of the first energy producer is queried. In a mode combining the first and second energy producers, an individual mode power value determined for the first energy producer by the first soft sensor is read in here. Furthermore, a second soft sensor determines a first power value for the first energy producer and a second power value for the second energy producer. In addition, a total power of the energy producers is determined.

### CROSS-REFERENCE TO RELATED APPLICATIONS

This application claims priority to PCT Application No. PCT/EP2016/080072, having a filing date of Dec. 7, 2016, based on German Application No. 10 2015 226 656.7, having a filing date of Dec. 23, 2015, the entire contents both of which are hereby incorporated by reference.

### FIELD OF TECHNOLOGY

The following relates to a method and a soft sensor for determining a power of a first energy producer, which is coupled with a second energy producer.

### BACKGROUND

Contemporary energy production systems often comprise a plurality of energy producers mechanically and/or electrically coupled with each other, which generate or convert energy from other forms of energy. Examples of such hybrid systems are gas turbines, which in order to increase their efficiency are operated in combination with steam turbines which use the waste heat from the gas turbines via a heat exchanger. Other examples are motor vehicles with hybrid drives.

Frequently, different energy producers, such as gas and steam turbines, are mechanically coupled with one another by acting on the same generator via a common mechanical shaft. Such systems are often designated as single-shaft systems. Systems in which different energy producers each have their own generator are accordingly also known as multi-shaft systems.

In contrast to multi-shaft systems, in single-shaft systems a power generated, for example, by a gas turbine can no longer be measured separately as soon as a steam turbine acting on the same shaft delivers a power contribution itself. The power specifically generated by the gas turbine, or more generally, by a first energy producer, is an important operating parameter however, the knowledge of which can contribute significantly to an optimal management of the operation of the gas turbine, or first energy producer.

In order to be able to determine the specific power of e.g. a gas turbine in combined operation with a steam turbine of a single-shaft system, so-called soft sensors are frequently used to determine the specific power of the gas turbine using a data-driven model created from other operating data. Such a soft sensor can be implemented, for example, by means of a neural network, which in a training phase, on the basis of the collected operating data, learns a mapping from measurable operational and environmental parameters to the power output by the gas turbine. Such a training phase is usually based on operational data which has been collected on a single-shaft system in the pure gas-turbine operation, in other words with an idling steam turbine, or on a multi-shaft system. Such a pure gas turbine operation is often referred to as “simple cycle”. The operating data based on such operating conditions, however, usually do not cover the entire operating parameter space of a single-system in the combined operating mode, particularly in view of the fact that the idling steam turbine can have a reverse action on the gas turbine. Moreover, operating data from turbines of the same type are only partly transferable due to production-related scatter and location differences.

### SUMMARY

An aspect relates to a method and a soft sensor for determining a power of a first energy producer that is coupled to a second energy producer, which allow a more accurate and/or more flexible power determination.

In order to determine a power output by the first energy producer, wherein the first energy producer is coupled to a second energy producer, a first soft sensor is queried, which is trained to determine an individual mode power value of the first energy producer. The first and second energy producers can be, e.g., energy producers for producing mechanical energy, electrical energy, magnetic energy and/or heat energy, such as turbines, generators, motors, solar modules, etc. or combinations of these. The first energy producer can be preferably coupled with the second energy producer by mechanical, electrical, magnetic and/or mixed means. In an operation combining the first and second energy producer, an individual-mode power value for the first energy producer determined by the first soft sensor is read in. In addition, a second soft sensor determines a first power value for the first energy producer and a second power value for the second energy producer. In addition, a total output of the energy producers is determined. The first or second power value can be determined in particular in absolute terms or relative to the second or first power value, or relative to the total power. According to embodiments of the invention, the second soft sensor is trained in such a way that an individual deviation between the individual-mode power value and the first power value and a total deviation between the total power and a combination of the first and second power value is reduced, and preferably minimized. The first power value is output. In connection with the soft sensors, a training process can be understood to mean in particular that a mapping of input parameters of the soft sensors onto one or more target variables is optimized according to definable criteria during a training phase.

For the implementation of the method according to embodiments of the invention a soft sensor, a a computer program product (non-transitory computer readable storage medium having instructions, which when executed by a processor, perform actions) and a machine-readable storage medium are provided.

The method according to embodiments of the invention or the soft sensor according to embodiments of the invention can be embodied or implemented, for example, by one or more processors, application specific integrated circuits (ASIC), Digital Signal Processors (DSP) and/or so-called “Field Programmable Gate Arrays” (FPGA).

By means of embodiments of the invention the power output by the first energy producer in the combined operating mode can be determined much more precisely than by a soft sensor which is only trained in the individual mode. In particular, by taking into account both the individual deviation as well as the total deviation in the training of the second soft sensor, a prediction for the first power value can be to some extent “pulled” in the direction of an individual-mode prediction. This means an unwanted propagation of modelling errors between the soft sensor models for the first and the second energy producer can be effectively attenuated or reduced.

Advantageous embodiments and extensions of the invention are specified in the dependent claims.

According to an advantageous embodiment of the invention, the individual deviation and a first part of the total deviation can be assigned to the first energy producer and a remaining part of the total deviation can be assigned to the second energy producer. The second soft sensor can then be trained in such a way that the assigned deviations, i.e. the individual deviation as well as the first and second part of the total deviation, are reduced, preferably minimized, in a way which is specific to the energy producer.

In particular, the total deviation can be allocated to the first part and the remaining part in a specified ratio.

The specified ratio can substantially correspond to a power ratio between the first energy producer and the second energy producer. In the coupled operation of a gas turbine with a steam turbine (single-shaft operation), the ratio used can have a value of approximately 2:1, for example, a value can be specified, which typically corresponds to the power ratio. Such a ratio is often known in advance and often exhibits only a slight variation.

By means of the above-described variants of the assignment and distribution of the deviations, an unwanted propagation of model errors between soft sensor models for the first and the second energy producer can be further reduced.

Advantageously, the individual-mode power value and/or the first power value are determined on the basis of operating data of the first energy producer and/or the second power value is determined on the basis of operating data of the second energy producer. The operating data can comprise such items as default values, control data and/or measurement data.

According to an advantageous embodiment of the invention, the first and/or the second soft sensor can be implemented using a data-driven trainable regression function and/or by means of a neural network.

In addition, the first power value can be determined by means of a neural network part associated with the first energy producer, the second power value by means of a second neural network part associated with the second energy producer, and the total deviation and the individual deviation by means of a further neural training layer. The first or second partial neural network can comprise an energy-producer specific neural model of the first or second energy producer respectively, or form such a model in the course of the training. In this way, energy-producer specific data can usually be better captured and/or determined.

In particular, neural parameters and/or neural weights of the trained first neural network part can be specifically extracted and transferred to a third soft sensor. In this way, it is possible to significantly improve the accuracy of a third, external soft sensor when determining the power output by the first energy producer. A third soft sensor modified in this way can also frequently be used in conventional systems without further changes.

Advantageously, in the combined operating mode the second soft sensor can be regularly re-trained and/or continuously trained. This can preferably be performed by unsupervised training methods.

According to an advantageous embodiment of the invention, a first power of the first energy producer can be measured and compared with the first power value, and/or a second power of the second energy producer can be measured and compared with the second power value. Depending on the comparison result, a deviation signal can then be output. A monitoring function can thus be implemented by the second soft sensor being trained on an intact system and in the event of deviations of a calculated power value from a measured power, for example, a malfunction is inferred and an error signal output.

### BRIEF DESCRIPTION

Some of the embodiments will be described in detail, with reference to the following figures, wherein like designations denote like members, wherein:

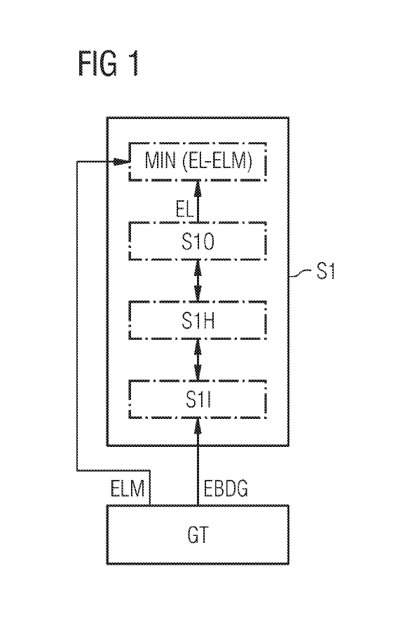

FIG. 1 is a first soft sensor and an energy producer operated in an individual operating mode;

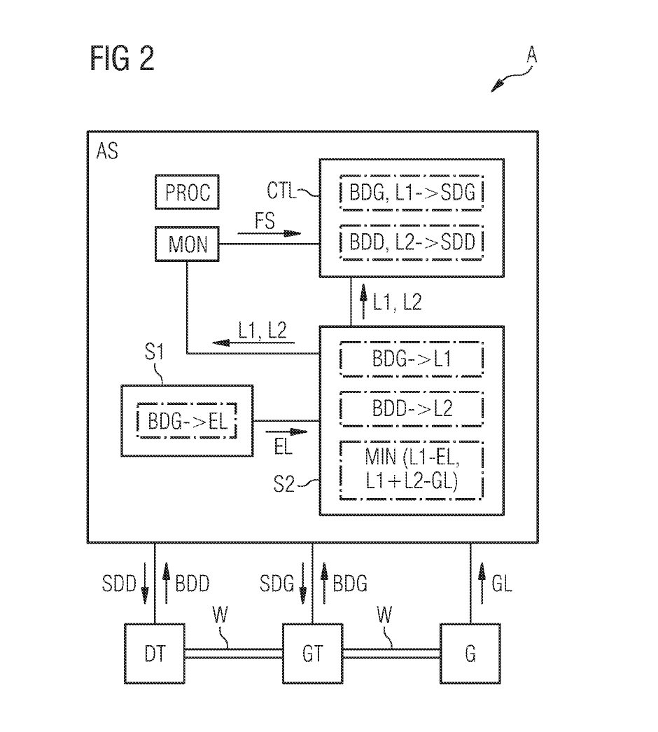

FIG. 2 is a power generating plant with a second soft sensor according to embodiments of the invention and with energy producers operated in a combined mode; and

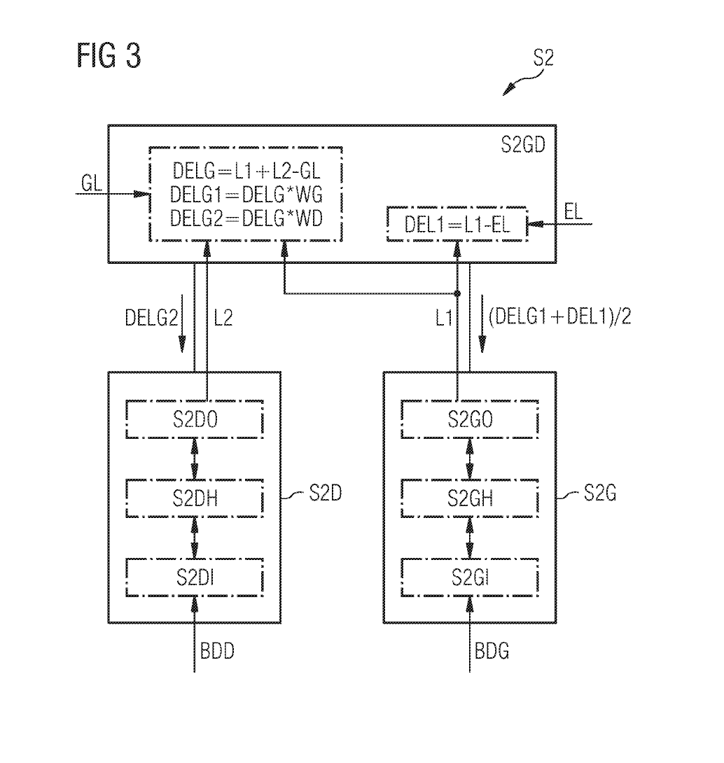

FIG. 3 is the second soft sensor in a more detailed view.

### DETAILED DESCRIPTION

FIG. 1 shows a schematic representation of a first soft sensor S1 for determining an individual-mode power value EL for a power of a first energy producer GT in the individual mode. The individual-mode power value EL is determined from individual operating-mode data EBDG of the first energy producer GT. The individual operating data EBDG can be physical, control-engineering and/or design-related operating variables, properties, default values, control data and/or measurements of the first energy producer GT. The first energy producer GT can be, for example, an energy producer for generating mechanical energy, electrical energy, magnetic energy and/or heat energy, for example a turbine, a generator, a motor, a solar module or a combination of these. In the present exemplary embodiment, a gas turbine GT will be considered as the first energy producer.

The first energy producer GT is operated in the operating phase described in FIG. 1 for training the first soft sensor S1 in an individual operating mode. The first energy producer GT can be a gas turbine which is operated in a single-shaft system in the pure gas turbine mode (simple cycle), in other words with a disconnected or output-free co-rotating steam turbine, or else a gas turbine in a multi-shaft system.

The first soft sensor S1 in the present exemplary embodiment is implemented by a self-learning neural network, which has an input layer S1I for reading in the individual operating data EBDG, one or more hidden layers S1H and one output layer S1O for outputting an individual-mode power value EL. The input layer S1I and the output layer S1O are each coupled to the hidden layers S1H.

In the individual operating mode of the first energy producer GT the first soft sensor S1 is trained to provide a maximally accurate determination of the individual-mode power value EL for the first energy producer GT. For this purpose, the individual-mode data EBDG of the first energy producer GT are detected and fed into the input layer S1I of the first soft sensor S1. From the individual operating data EBDG, as a result of their propagation through the hidden layers S1H to the output layer S1O, an individual-mode power value EL of the first energy producer GT is determined.

Additionally, an individual power ELM of the first energy producer GT in the individual mode is measured and transmitted to the first soft sensor S1, where it is compared with the individual-mode power value EL determined by the first soft sensor S1. Based on this, the first soft sensor S1 is trained in such a way that a deviation between the individual-mode power value EL and the measured individual power ELM, for example a modulus of a difference EL-ELM, is minimized with respect to a minimization target value MIN in the individual mode. This training can be implemented, for example, by back propagation training.

After sufficient training the trained first soft-sensor S1 can determine an individual-mode power value EL from the individual-mode data EBDG even without recourse to a measured individual power ELM, usually with high accuracy.

FIG. 2 shows a schematic representation of a power generation plant A with a plurality of energy producers operating in combined mode. The power generation plant A can be a power plant or a hybrid drive of a motor vehicle, for example. In the present exemplary embodiment the power generation plant A comprises a single-shaft system with a gas turbine GT as the first energy producer and a steam turbine DT as the second energy producer. In the single-shaft system, the gas turbine GT and the steam turbine DT are mechanically coupled to each other, to the extent that they both act upon a common shaft W.

In the operating mode described in FIG. 2, the gas turbine GT and the steam turbine DT are operated in combined mode, i.e. both energy producers DT and GT output power to the common shaft W. Such a combined exothermic or combined operation is also often referred to as “Combined Cycle” or GaS (gas and steam) operation. This is usually a productive or regulated operating mode of such a power generation plant A.

The gas turbine GT can be a gas turbine described in connection with FIG. 1 in the individual operating mode, or a gas turbine of the same or a similar type.

The steam turbine DT uses waste heat from the gas turbine GT via a heat exchanger for its operation, to increase the efficiency of the power production plant A.

Alternatively, or in addition to the gas turbine GT and the steam turbine DT, other energy producers can also be provided for generating mechanical energy, electrical energy, magnetic energy, heat energy, etc., such as turbines, generators, motors, solar modules etc., or combined forms of them.

The gas turbine GT and steam turbine DT output power via the common shaft W to a power generator G, which collects mechanical energy from the shaft W and converts it into electrical energy. Alternatively or in addition to the mechanical coupling of the energy producers GT and DT, these can also be electrically and/or magnetically coupled. Because of this coupling, the individual power levels output by the energy producers GT and DT cannot be directly determined.

The power generation plant A is equipped with a plant control system AS for controlling it, which has one or more processors PROC for performing all the method steps of the plant control system AS. The control system AS is coupled to the energy producers GT and DT as well as to the power generator G.

The plant control system AS is used to send control data SDG to the gas turbine GT to control the gas turbine GT, and to send control data SDD to the steam turbine DT to control the steam turbine DT. This control is performed as a function of operating data BDG of the gas turbine GT and as a function of operating data BDD of the steam turbine DT, so that its operation is managed in an optimum way, for example with regard to efficiency, wear and/or harmful emissions.

The operating data BDG and BDD can be physical, control-engineering and/or design-related operating variables or properties of the energy producers GT or DT, and relate, for example, to a fuel mass flow, turbine vane positions, an operating temperature, exhaust gas temperature, vibrations, pressure, ambient conditions or other specifiable values, control parameters, control data and/or measurements. By means of the plant control system AS the operating data BDG are at least partially read in from the gas turbine GT and the operating data BDD are at least partially read in from the steam turbine DT. In addition, the operating data BDG can in particular also comprise the control data SDG and the operating data BDD can at least partially comprise the control data SDD.

In addition, a total power GL of the combined-operation energy producers GT and DT is measured at the power generator G and transmitted to the plant control system AS.

The plant control system AS is provided with the first soft sensor S1 described in connection with FIG. 1. This was trained in advance—as also described in conjunction with FIG. 1—to determine an individual-mode power value EL on the basis of operating data of the gas turbine GT in an individual operating mode, or on the basis of operating data of a gas turbine of identical or similar type.

In the combined operation illustrated by FIG. 2, the current operating data BDG of the gas turbine GT are transmitted to the first soft sensor S1. From the transmitted operating data BDG of the combined operating mode, the first soft sensor S1 then determines a current individual-mode power value EL. The individual-mode power value EL is then transmitted from the first soft sensor S1 to a second soft sensor S2 coupled thereto.

The second soft sensor S2 in the present exemplary embodiment is implemented by a self-learning neural network, which is trained in the combined operation of the energy producers GT and DT to determine power values L1 and L2 for individual power levels of the energy producers GT and DT. In this case, L1 is a first power value of the individual power of the gas turbine GT in the combined operating mode and L2 is a second power value for the individual power of the steam turbine DT in the combined operating mode.

To determine the power values L1 and L2, current operating data BDG and BDD, a current individual-mode power value EL and a current measurement of the overall power GL are read in by the second soft sensor S2. The second soft sensor S2 then determines the first power value L1 on the basis of the operating data BDG, and the second power value L2 on the basis of the operating data BDD. In this case, the second soft sensor S2 is trained with respect to a minimization target MIN in such a way that an individual deviation L1−EL and a total deviation L1+L2−GL are minimized. Preferably, the second soft sensor S2 can be continuously trained and/or regularly re-trained in the combined operating mode. The determined power values L1 and L2 are transmitted from the second soft sensor S2 to a turbine control system CTL of the plant control system AS, which is coupled to the second soft sensor S2.

The turbine control system CTL is used to control both the gas turbine GT and the steam turbine DT. To this end, based on the power values L1 and L2 and based on the operating data BDG and BDD, the turbine control system CTL determines a current operating status of the turbines DT and GT. Depending on this operating status, the turbine control system CTL determines the optimized control data SDG and SDD for the optimized operational management of the turbines GT and DT, for example with regard to efficiency, wear and/or harmful emissions. The control data SDG and SDD are accordingly transmitted to the turbines GT and DT for the purposes mentioned above.

In accordance with an extension of embodiments of the invention, the second soft sensor S2 transmits the power values L1 and L2 to a monitoring module MON of the plant control system AS. The monitoring module MON is coupled to both the second soft sensor S2 and the turbine control system CTL and is used for monitoring the gas turbine GT and the steam turbine DT. To this end, the monitoring module compares the transmitted power values L1 and/or L2 with specified and/or measured individual power levels of the gas turbine GT or steam turbine DT respectively. In the event of a deviation between the compared values, then assuming that the first and/or second soft sensor have been trained on an intact plant, a malfunction of the power generation plant A can be assumed to exist. To indicate the malfunction, an error signal FS is transmitted by the monitoring module MON to the turbine control system CTL, which initiates appropriate control measures as a result.

FIG. 3 illustrates the second soft sensor S2 in a more detailed view. Here, the reference numerals S2, BDG, BDD, L1, L2, EL and GL designate the same objects as in FIG. 2.

The second soft sensor S2 comprises a first neural network part S2G for modelling the gas turbine GT and for determining the first power value L1 based on the operating data BDG. The first neural network part S2G has an input layer S2GI for reading in the operating data BDG, one or more hidden layers S2GH and one output layer S2GO for outputting the first power value L1. The input layer S2GI and the output layer S2GO in this case are each coupled to the one or more hidden layers S2GH. The operating data BDG are fed into the input layer S2GI and via the one or more hidden layers S2GH are propagated to the output layer S2GO, which outputs the first power value L1.

The second soft sensor S2 also has a second neural network part S2D for modelling the steam turbine DT and for determining the second power value L2 based on the operating data BDD. The second neural network part S2D comprises an input layer S2DI for reading in the operating data BDD, one or more hidden layers S2DH and an output layer S2DO for outputting the second power value L2. The input layer S2DI and the output layer S2DO are each coupled to the one or more hidden layers S2DH. The operating data BDD are fed into the input layer S2DI and propagated through the one or more hidden layers S2DH to the output layer S2DO, which outputs the second power value L2.

The second soft sensor S2 also has a cross-energy-generator neural training layer S2GD, which is connected both to the first neural network part S2G and to the second neural network part S2D.

Alternatively or additionally, the first neural network S2G, the second neural network S2D and/or the training layer S2GD can be implemented by a plurality of neural networks or neural layers, each initialized with random weights. The output signals of the network parts S2G and S2D and/or the training layer S2GD are then each formed by averaging the outputs of the respective plurality of the neural networks or neural layers.

The individual-mode power value EL from the first soft sensor S1 and the measured total power GL of the power generator G are fed to the training layer S2GD. In addition, the first power value L1 determined by the first neural network S2G and the second power value L2 determined by the second neural network S2D are transmitted to the training layer S2GD. From the transmitted data GL, EL, L1 and L2 the training layer S2GD determines a total deviation DELG between the total power GL and a sum of the first power value L1 and the second power value L2, and an individual deviation DEL1 between the individual-mode power value EL and the first power value L1. In the present exemplary embodiment therefore, the equation for the total deviation is DELG=L1+L2−GL and that for the individual deviation is DEL1=L1−EL.

The total deviation DELG is allocated by the training layer S2GD into a first part DELG1 and a remaining part DELG2 in a specified ratio. To determine the allocation, the total deviation DELG is multiplied by specified weights WG and WD, whose sum is equal to 1. The first part DELG1 of the total deviation DELG is therefore given by DELG1=DELG·WG and the remaining part DELG2 of the total difference DELG by DELG2=DELG·WD.

The first part DELG1 together with the individual deviation DEL1 is assigned specifically to the gas turbine GT, while the remaining part DELG2 is assigned specifically to the steam turbine DT. The ratio WG:WD of the weight WG assigned to the gas turbine GT to the weight WD assigned to the steam turbine DT is preferably defined in accordance with a power ratio of the gas turbine GT to the steam turbine DT. For a single-shaft operating mode of a gas turbine with a steam turbine, a ratio WG:WD=2:1 is typically specified, which is to say WG=2/3 and WD=1/3. The specification of a weight ratio corresponding to the power ratio reflects to some extent the influence of the turbine models and their model errors on the power calculation, and so acts as a stabilizing effect on the training. In addition, this ratio is normally known in advance and in operation often only exhibits a small variation.

The second part DELG2 of the total deviation DELG is fed into the second neural network part S2D as a prediction error of the second neural network part S2D for the second power value L2, in order to train this network on an energy-producer-specific basis to minimize this prediction error. This training can preferably be performed by back-propagation training.

The first part DELG1 of the total deviation DELG is combined with the individual deviation DEL1 before being propagated back, and the combination, for example the mean value (DELG1+DEL1)/2, is fed into the first neural network part S2G as the prediction error of the first neural network part S2G for the first power value L1. The latter network is thus trained on an energy-producer-specific basis, for example using back propagation training, to minimize this prediction error.

Each of the trained neural network parts S2G and S2D then comprises an energy-producer-specific neural model of the gas turbine GT or the steam turbine DT for determining the respective power value L1 or L2.

By the admixture of the individual deviation DEL1 to the first part DELG1 of the total deviation DELG, the prediction of the first neural network part S2G is to some extent “pulled” in the direction of an individual-mode prediction. This allows an unwanted propagation of modelling errors of the second neural network part S2D into the neural model of the gas turbine GT in the first neural network part S2G to be effectively attenuated or reduced.

As a result of the training, both the prediction error for the total power GL and the prediction error for the gas turbine power are minimized. This means that via the weighting of the deviation values DELG, DEL1, DELG1 and DELG2 it is possible to some extent to adjust the extent to which the neural sub-model of the gas turbine GT in the first neural network part S2G may differ relative to the first soft sensor S1. As a result of this weighting, it is possible on the one hand, for the first neural network part S2G to differ from the pre-trained first soft sensor S1 and yet an undesirable propagation of model errors of the second neural network part S2D into the first neural network part S2G is still effectively attenuated.

It can be observed that a soft sensor, here S2, trained according to embodiments of the invention can determine a significantly more accurate power value for the individual power of the gas turbine GT from the operating data BDG in combined operation than a soft sensor, here S1, which is only trained in the individual mode. Since significantly more operating data or measurement data are typically available for the combined gas and steam operation and the power range of a combined operation is larger and closer to actual practice than an individual mode, this procedure allows gas turbine models, or energy producer models in general, to be created with higher accuracy and for a broader range of applications than is possible with known soft sensors. This reduces the previous difficulty of capturing a sufficient amount of operating data in the individual mode, or of finding energy producers with similar operating patterns in multi-shaft installations. The additional training phase in the combined operation, i.e. also in productive operation, generally enables the gas turbine model trained in the individual mode to be considerably refined.

In addition, neural weights of the first neural network part S2G can be selectively extracted and transferred to an existing, third soft sensor. By this method, the accuracy of existing soft sensors can be significantly improved.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A method for determining a power output by a first energy producer, wherein the first energy producer is coupled to a second energy producer, wherein
a) a first soft sensor which is trained to determine an individual mode power value of the first energy producer is queried, and
b) in an operating mode combining the first and second energy producers,
an individual-mode power value determined for the first energy producer by the first soft sensor is read in,
a second soft sensor determines a first power value for the first energy producer and a second power value for the second energy producer,
a total power of the energy producers is determined,
the second soft sensor is trained in such a way that an individual deviation between the individual mode power value and the first power value and a total deviation between the total power and a combination of the first and second power values are reduced, and
the first power value is output.

2. The method as claimed in claim 1, wherein the individual deviation and a first part of the total deviation are assigned to the first energy producer, and a remaining part of the total deviation is assigned to the second energy producer, and
that the second soft sensor is trained in such a way that the assigned deviations are reduced in a way that is specific to the energy producer.

3. The method as claimed in claim 2, wherein the total deviation is allocated to the first part and the remaining part in a specified ratio.

4. The method as claimed in claim 3, wherein the specified ratio substantially corresponds to a power ratio between the first energy producer and the second energy producer.

5. The method as claimed in claim 1, wherein
the individual mode power value and/or the first power value is/are determined on the basis of operating data of the first energy producer and/or the second power value on the basis of operating data of the second energy producer.

6. The method as claimed in claim 1, wherein
the first and/or the second soft sensor is/are implemented using a data-driven trainable regression function and/or by a neural network.

7. The method as claimed in claim 1, wherein
the first power value is determined using a first neural network part assigned to the first energy producer,
the second power value is determined using a second neural network part assigned to the second energy producer and
the total deviation and the individual deviation are determined by a further neural training layer.

8. The method as claimed in claim 7, wherein neural parameters of the first trained neural network part are specifically extracted and transferred to a third soft sensor.

9. The method as claimed in claim 1, wherein
the second soft sensor in the combining operation is regularly re-trained or trained on a continuing basis.

10. The method as claimed in claim 1, wherein
a first power of the first energy producer is measured and compared with the first power value and/or
a second power of the second energy producer is measured and compared with the second power value, and
that a deviation signal is output depending on the result of the comparison.

11. A soft sensor for determining a power output by a first energy producer, configured for implementing a method as claimed in claim 1.

12. A computer program product, comprising a computer readable hardware storage device having computer readable program code stored therein, said program code executable by a processor of a computer system to implement a method which is configured for implementing a method as claimed in claim 1.

13. A machine-readable data storage medium with a computer program as claimed in claim 12.
